(19) United States
(12) Patent Application Publication
(10) Pub. No.: US 2001/0049627 A1
(43) Pub. Date: Dec. 6, 2001

(54) Method and system for distribution of electronic coupons

(76) Inventor: William E. Simpson, Lake Oswego, OR (US)

Correspondence Address: WHITEFORD, TAYLOR & PRESTON, LLP, ATTN: GREGORY M STONE, SEVEN SAINT PAUL STREET, BALTIMORE, MD, 21202-1626, US

(21) Appl. No.: 09/795,218

(22) Filed: Feb. 28, 2001

Related U.S. Application Data
(60) Provisional application No. 60/185,686, filed on Feb. 29, 2000.
(60) Provisional application No. 60/244,373, filed on Oct. 30, 2000.

(51) Int. Cl. G06F 17/60

(52) U.S. Cl. 705/14

(57) ABSTRACT

Disclosed is a method and system enabling the electronic dissemination of electronic coupons combined with both coupon-related and coupon-unrelated information stored on a computer readable storage medium, and a control program limiting a user's access to only such coupons as have been authorized through user input of an access code.

### CROSS-REFERENCE TO RELATED APPLICATIONS

The present application is based upon and gains priority from U.S. Provisional Patent Application Ser. No. 60/185,686, filed Feb. 29, 2000, by the inventor herein and entitled “CouponCD/CDCoupon,” and U.S. Provisional Patent Application Ser. No. 60/244,373, filed Oct. 30, 2000, by the inventor herein and entitled “Method and System for Distribution of Electronic Coupons.”

### BACKGROUND OF THE INVENTION

1. Field of the Invention

The present invention relates to the electronic dissemination of consumer coupons, and more particularly to a method and system enabling the electronic dissemination of electronic coupons combined with both coupon-related and coupon-unrelated information stored on a computer readable storage medium, and a control program limiting a user's access to only such coupons as have been authorized through user input of an access code.

2. Description of the Background

Consumers are often induced to make purchases as a result of varied forms of advertising. One often utilized advertising method is providing promotional discounts on particular goods or services in the form of printed coupons. Such printed coupons are often printed in full color and in massive quantities for distribution through such mediums as newspapers, advertising brochures, magazines, and the like, at significant expense. Seeing such a coupon, a purchaser will at times elect to purchase the coupon provider's goods or services solely because they feel they are getting a “bargain” in obtaining such a discount, often times in spite of the fact that the purchaser would not have considered purchasing such product or service without having been faced with a coupon in the first place.

Unfortunately, however, the vast numbers of coupons available in such print media often times results in consumers refusing to search through large collections in order to obtain what many consider may be a minute discount. Often times, only consumers on a very tight budget or those with a plethora of free time will exert the necessary effort of searching through collections of coupons normally distributed through mass media.

An alternative to this mass-produced printed coupon distribution medium has been the distribution of printed coupon books containing collections of consumer-orientated discounts in a single bound volume. While such a collection provides a single, centralized repository for coupons, such coupon books are often large, heavy bound volumes, and often cost from $25.00 to $50.00, and many consumers are unwilling to make such an investment for fear of no return of that investment through the coupons in the bound volume.

Likewise, the traditional coupon distribution medium provides significant disadvantages to the coupon advertisers and sponsors. Publication and advertising placement costs may be quite significant. For larger coupon books, manufacturing costs may reach $7.00 per book, leaving little profit margin, and often carry significant distribution costs. Coupon placement for each advertiser is also an issue, and once a coupon is cut from the book, the advertiser is no longer positioned to receive any additional ad impressions or sales opportunities. Additionally, all ad and coupon copy is fixed once the publication goes to press, such that there is no possibility for any real-time updates, offers, or changes in the offers by advertisers.

Further, due to the difficulty in managing the aggregate number of potential coupons and advertisers in each coupon book, coupons that are to be distributed in coupon books are often broken down and sold by geographic region. Thus, an end user of the coupon book will traditionally purchase a coupon book for the geographic region in which such user resides, for example the individual state of residence of the end user, and distributors will sell the coupon books at retail prices ranging from $10.00 to $40.00 per state. Thus, if the user finds himself travelling outside of his or her own state and requires coupons for car rentals or hotels, the user would need to have already purchased additional coupon books for those states in which he or she is now travelling.

Still further, consumers of such coupon books may find only a limited number of discount offers particularly suited for their needs. Because the coupons provided in such a coupon book must be forever removed and surrendered to a product or service provider, the fact that the coupon book provides the consumer with only a single opportunity to use the coupon limits its usefulness and desirability to such a consumer.

Attempts have been made in the past to provide alternate means of distributing consumer rebates, coupons, or other offers, such as through the Internet, diskettes, email, etc. For example, there are currently a number of web sites accessible via the Internet that provide various means by which users may select coupons to print on their own computer. In order to use such a service, a consumer is ordinarily required to “register” themselves as a user of such a service by providing personal information, such as their name, address, telephone number, and often times personal consumer characteristics and preferences that the service provider may later use themselves for more directed marketing efforts, or sell to others for their marketing use. Likewise, coupon providers may incur substantial expense in seeking to provide their discount offers through such a service, as the only way in which such a service provider may derive a profit is to charge advertisers for coupon placement, and possibly charge per each coupon downloaded. Further, such an online method for distributing coupons necessarily requires that a user have access to an Internet connection in order to obtain and use the coupons. Such a mandatory Internet connection reduces the potential number of consumers who are able to benefit from the use of such a coupon distribution system, and likewise increases a user's exposure to computer viruses which may inadvertently be obtained through Internet downloads. Even further, such an online method for distributing electronic coupons causes the user to experience significant wait times when downloading individual coupons. Bandwidth limitations limit the amount of data that may be included in any single coupon record, and users seeking to obtain a large number of coupons may find themselves waiting for excessively long periods of time.

Another example of previous methods and apparatus for distributing electronic coupons is shown in U.S. Pat. Nos. 5,710,886 and 6,035,280 to Christensen et al. in which a list of consumer's names and addresses is generated as a “target list” to receive mass mailings of a diskette bearing electronic coupons. Upon receipt of the diskette, a user is required to phone a toll free number or access a remote server in order to provide identification and demographic information, such as the user's name, address, income level, marital status, number of children, etc. After the toll free operator or remote server confirms that the user is in fact the particular targeted consumer, the user is provided an authorization number to unlock the software on the diskette, in turn enabling the user to then view and print a limited, pre-designated number of each coupon stored on the diskette.

While Christensen does seek to provide a means of distributing consumer coupons that improves upon the traditional distribution scheme for paper coupons, it does carry significant disadvantages. More particularly, while a single diskette may be produced and distributed to a select demographic or geographic population, customization for varying demographic populations or geographic regions requires the creation of separate diskettes for each such population or region. Production of such customized diskettes increases manufacturing costs such that wide scale distribution may be prohibitively expensive. Further, Christensen particularly requires that coupons provided through the apparatus be limited to a particular number of uses, such that even a diverse collection of coupons may have little functionality for consumers who are particularly suited to benefit from only a small portion of that collection. Likewise, having content limited to coupon offers and advertising information, consumers are provided little additional incentive to engage in the task of sifting through a large collection of coupons in order to identify a possibly relevant or desirable discount offer, and thus are no more likely to review an electronic collection of coupons than they are to review a collection of print coupons. Even further, Christensen particularly requires that a user contact a remote location via Internet connection or telephone as an absolute prerequisite to accessing and using any of the coupons, and during such contact solicits personal information from the user which may result in the user being later bombarded with “junk mail.”

Thus, a need exists for a more compact, easily manufacturable, transportable and distributable coupon collection which enhances the functionality of previously known coupon distribution systems to ensure continued user interest and more wide-spread usability, and which allows for distribution of a single collection of coupons, rebates, discounts, or other offers to geographically, demographically, or otherwise identifiably segmented populations with means to customize the select offers made available to each population.

### SUMMARY OF THE INVENTION

It is therefore an object of the instant invention to provide a method and system for distributing coupons that avoids the disadvantages of the prior art.

It is another object of the instant invention to provide a method and system for distributing electronic coupons that combines a collection of coupons with coupon-unrelated information and utilities provided to entertain a user and to encourage review of all of the coupon records in the collection.

It is still another object of the instant invention to provide a method and system for distributing electronic coupons that includes the presentation of multimedia information.

It is still even yet another object of the instant invention to provide a method and system for distributing electronic coupons that enables the collection of consumer-related information.

It is even yet another object of the instant invention to provide a method and system for distributing electronic coupons that allows the sharing of information between coupon users and a coupon provider.

It is even yet another object of the instant invention to provide a method and system for distributing electronic coupons that allows the distribution of a single collection of coupons, rebates, discounts, or other offers to geographically, demographically, or otherwise identifiably segmented populations with means to customize the select offers made available to each such population.

It is still even yet another object of the instant invention to provide a profitable method and system for distributing electronic coupons that does not require charging a coupon provider a coupon placement fee or coupon download fee.

It is even yet another object of the instant invention to provide a method and system for distributing electronic coupons which does not require a remote communication in order to print and use the coupons.

These and other objects and advantages are achieved by the present invention which provides a method and apparatus for the distribution of electronic coupons, rebates, discounts, or other offers. A consumer purchases a package comprising a computer readable storage medium, such as a CD-ROM, DVD, diskette, or the like, bearing electronic coupons, coupon-related information (such as textual information and multimedia displays relating to the particular coupon, rebate, or discount offers provided on the CD-ROM), coupon-unrelated information (such as games, trivia, and textual and multimedia presentations not relating to the particular coupon, rebate, or discount offers provided on the CD-ROM), and a control program which limits a user's access to a distinct selection of coupons. The CD-ROM is provided to a user in combination with a booklet, card, or label indicating an access code configured as input for the control program to direct the control program to enable a user to access only a select group of coupons from the entire collection of coupons stored on the CD-ROM. In a preferred embodiment, the control program will enable a user to view all coupon records stored on the CD-ROM, while limiting a user's access to a print function enabling the printing of coupons, such that only those coupons for which a valid access code has been input by the user may be printed. After inputting a valid access code, users may then print as many copies as the users desire of each coupon for which the print function has been enabled. Imprinting certain items of a user's personal information on each printed coupon enables an employee of a retail establishment to confirm that the user who actually purchased the CD-ROM is in fact the person redeeming the coupon or other discount offer, thus deterring the use of coupons by unauthorized persons.

The coupon records stored on the CD-ROM preferably provide the user with a link to the coupon provider's Internet web site. Upon connecting to the provider's web site, certain demographic information relating to the user may be automatically transferred to the coupon provider for purposes of tracking statistical demographic information relating to users of each coupon provider's goods and services. Likewise, in the event a coupon provider wishes to update coupon offers previously provided on the CD-ROM, they may make the users aware of the availability of such additional or modified offers upon their visit to the web site.

### BRIEF DESCRIPTION OF THE DRAWINGS

Other features, objects and advantages of the subject invention will become apparent from a study of the following specification when viewed in light of the accompanying drawings, in which:

FIG. 1 is a flowchart graphically depicting the method of the instant invention.

FIG. 2 is a schematic diagram of the software of the instant invention.

FIG. 3 is a flowchart graphically depicting the software method of the instant invention.

FIG. 4 is a graphical representation of a user interface of the instant invention.

FIG. 5 is a graphical representation of a single coupon record.

### DETAILED DESCRIPTION OF THE PREFERRED EMBODIMENTS

The method and system of the instant invention provide a means by which a single collection of coupons, rebates, discount offers, or other consumer incentives may be provided in a common distribution medium with means for limiting the redemption of such consumer incentives to limited, identifiably segmented populations, such as to consumers within a particular geographic area, consumers having a common demographic trait, or consumers of particular classes or groups of goods or services, such as travel service consumers, sporting event consumers, sporting goods consumers, restaurant service consumers, etc. The apparatus comprises a computer readable storage medium, such as a CD-ROM, DVD, diskette, or the like, containing a number of “electronic coupons,” which comprise computer-readable files having textual and optionally graphical or multimedia information relating to a particular discount offer, which information may be displayed to a user through use of a standard personal computer equipped with a drive capable of receiving and accessing information stored on the computer readable storage medium. A control program is also provided for controlling a user's access to such electronic coupons, and more particularly in a preferred embodiment of the instant invention, limiting a user's access to a print function enabling the selective printing of such electronic coupons. Also provided on the CD-ROM is textual, graphical, multimedia, and/or interactive programs which are unrelated to the coupon offers stored on the CD-ROM, such as games, stories, movies, or other entertainment items, but which may optionally include links to such electronic coupon offers upon the happening of certain events. For example, a game may be provided on the CD-ROM unrelated to the specific discount offers provided on the CD-ROM which, upon the user achieving a predetermined score in the game, rewards the user with access to a particular coupon, gift certificate, or other discount offer stored on the CD-ROM. Alternately, a multimedia presentation may be provided on the CD-ROM discussing a particular professional sports team or player which, at the end of such presentation, displays to the user a particular collection of coupons or other discount offers relating to sporting goods or discounts off of sporting events.

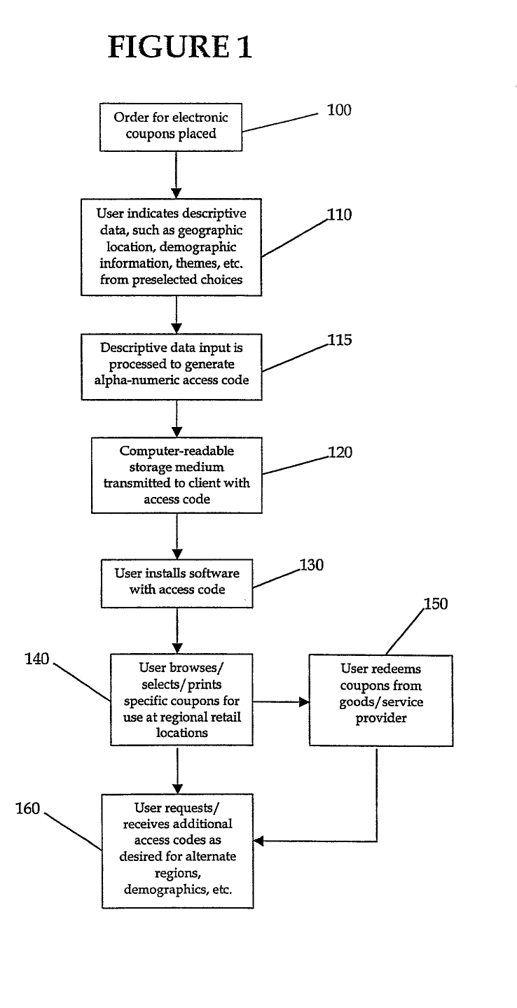

The method of the instant invention is shown in the summary flowchart of FIG. 1. At step 100, a consumer, wishing to obtain discounts on future purchases of a variety of goods and services, places an order for a CD-ROM, DVD, high density floppy disk drive, or similarly configured computer readable storage medium containing a variety of electronic coupons and software for controlling a user's access to those coupons. As will be described in greater detail below, such a CD-ROM is preferably provided with a number of coupons relating to product and service providers that may be arranged into separately distinguishable groups, based upon demographic traits of consumers to whom the coupon offers are directed, geographic regions in which the coupon offers may be redeemed, or particular classes of goods or services to which the coupon offers relate. Each such distinguishable group is in turn assigned an access code comprising a unique, random alpha-numeric code configured as input to the control program on the CD-ROM.

In a first embodiment of the instant invention, when an order is placed for a CD-ROM having such electronic coupons, at step 110 the user indicates descriptive date, such as the particular geographic area of the user, and at step 115, such data is analyzed and assigned a regional access code corresponding to that specific geographic area. For example, the regional access codes stored on the CD-ROM may comprise groupings of postal zip codes, and the order-originating consumer's zip code may be cross-referenced against the groupings of zip codes stored on the CD-ROM, such that the appropriate regional access code may in turn be associated with that consumer's particular order. Alternately, the regional access codes stored on the CD-ROM may comprise groupings of particular states and cities, and the order-originating consumer's state may be cross-referenced against the states listed on the CD-ROM, such that the appropriate regional access code designating the consumer's state may in turn be associated with that consumer's order. As mentioned above, the use of such regional access codes to limit a consumer's access to particular coupons stored on the CD-ROM enables the software of the instant invention to be mass produced in a single version, as opposed to having separate versions for each distinct geographic area, in turn reducing manufacturing costs and inventory requirements for individual order fulfillment facilities.

In an alternate embodiment of the instant invention, a us7er may be presented with a listing of various distinct regions from which the user may select a particular collection of coupons. Upon selecting a particular region, such as by pull-down menu or by “clicking” on a graphical image of a map using a computer mouse or similarly configured pointing device, a regional access code identifying the indicated region is associated with that particular consumer's order.

In yet another alternate embodiment of the instant invention, a user may be presented with pull down menus or other similarly configured selection tools from which a user may indicate, by way of example only, gender, age, hobbies and interests, occupation, or any other information which may be useful in customizing the coupons or discount offers that will be made available to such user. Thus, for example, a user who indicates that they are a female, age 25-30, with interests in outdoor activities and cooking, and an annual income of over $50,000.00 may result in the generation of an access code which provides that user access to all coupons relating to sporting goods, sporting events, jewelry, flowers, dining, cooking, and banking and investment services.

In even yet another alternate embodiment of the instant invention, a user may select a particular “theme” or a specific class of goods and services from a predesignated listing of such themes or classes, such as, by way of example only, sports, fashion, entertainment, etc. Thus, should a user select a sports theme, an access code may be generated which provides that user access to all coupons relating to sporting goods, sporting events, and the like.

Thus, while a noncustomized CD-ROM, DVD, or the like having a standard collection of coupons and a control program may be manufactured and provided to such user, the access code enables the control program to customize the collection of coupons made available to such a user to account for varying geographic areas, demographics, or interests of the users.

A consumer may place an order for a CD-ROM (step 100) by contacting an electronic coupon distribution center by telephone, facsimile, mail, or email, in which case such an order request will be processed and fulfilled by an individual at the distribution center, or may alternately access a remote server across a wide area network such as the Internet. Such a remote server preferably houses computer software which enables a user to remotely perform a commercial transaction to purchase a CD-ROM bearing such electronic coupons. When placing such an order through a remote server, and as explained more fully above, the consumer preferably selects particular coupon customization criteria, such as a specific geographic region in which the consumer intends to use the coupons from a list or available geographic regions, or particular demographic characteristics of themselves such as gender, age, hobbies, occupation, etc., and an alpha-numeric access code configured as input to the control program pertaining to the consumer's designated geographical region, demographic characteristics, or other coupon customization criteria is associated with that consumer's order.

After the appropriate access code has been associated with a particular consumer's order, an instruction booklet, card, or label is placed with the CD-ROM in a single package, the instruction booklet, card, or label bearing the access code that has been assigned to that consumer's order, and at step 120 the combined CD-ROM and instruction booklet, card, or label are shipped to the consumer.

After the consumer receives the CD-ROM, he may access the software and the coupons stored on the CD-ROM at step 130 by placing the CD-ROM in a compatible disc drive on a standard personal computer. As is described in greater detail below, when the software is first initiated on a consumer's local computer, the software prompts the user to enter the access code displayed on the instruction booklet, card, or label that was packaged with the CD-ROM.

Optionally, in addition to being prompted for an access code upon initiation of the software, the software may prompt a user to input certain demographic and biographic information, including by way of example only, the user's name, address, telephone number, email address, age, gender, and any other information that might be of marketing value to a coupon provider. As described in greater detail below, such information may be stored on the user's local computer in an associated user preference file and transmitted to a coupon provider upon the user's establishing contact with a remote server administered by such coupon provider. The coupon provider may then use such demographic information to determine usage of its products and services, and to thereby tailor future coupon offerings and other marketing promotions to maximize the effectiveness of such marketing efforts, and provide the user with any instant, real-time offers.

After the consumer has input a valid access code, the control program provides the consumer access to all coupons stored on the CD-ROM which are associated with such access code. Optionally, upon input of a valid access code, the control program may allow the consumer to view the entire collection of all coupons stored on the CD-ROM, while providing print capability only for such coupons for which a valid access code has been entered. At this point, a user may browse through the various coupons stored on the CD-ROM, including viewing multimedia presentations associated with any coupons, bookmark particular coupons for later quick retrieval, and print those coupons which are associated with the access code input by the consumer during the initiation process.

Once printed, the consumer may at step 150 then take the coupon to a retail establishment and redeem the coupon for a discount off of the cost of a product or service the coupon describes.

Optionally, in addition to being prompted for an access code upon initiation of the software, the software may also prompt a user to input certain demographic and biographic information, including by way of example only the user's name, address, telephone number, email address, age, gender, and any other information that might be of marketing value to a coupon provider. As described in greater detail below, such information may be stored on the user's local computer and transmitted to a coupon provider upon the user's establishing contact with a remote server administered by such coupon provider. The coupon provider may then use such demographic information to determine usage of its products and services, and to thereby tailor future coupon offerings and other marketing promotions to maximize the effectiveness of such marketing efforts.

As with traditional paper coupons, the coupons stored on the CD-ROM may have a designated expiration date. Should the consumer wish to purchase additional coupons after such expiration date, or likewise purchase coupons in alternate geographic locations or relating to alternate demographic populations or themes generally, the consumer may at step 160 cause the software to initiate remote communication with a remote server across a wide area network such as the Internet, as discussed in greater detail below. Such remote server preferably stores software for allowing a consumer to remotely purchase additional access codes which, after a purchase transaction is completed, automatically updates the software on the consumer's local computer to enable the consumer to print coupons associated with the newly purchased access code. Such remote server also preferably stores data files relating to all coupons stored on the CD-ROM, such that modifications, updates, or cancellations of particular coupons may be automatically transferred from the remote server to the consumer's local computer during each remote connection.

It should be noted that while the above description outlines the distribution of a physical CD-ROM bearing the software applications and information described herein, such software applications and information may alternately be distributed from a remote server to a user's local computer across a wide area network such as the Internet, without departing from the spirit and scope of the instant invention.

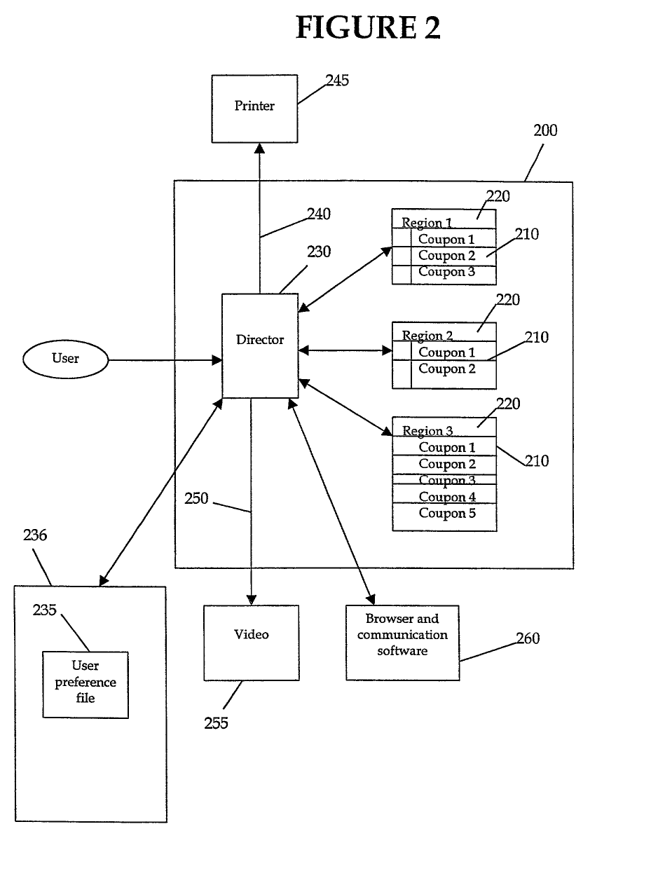

As shown in the schematic view of FIG. 2, the software of the instant invention comprises computer executable code 200 for enabling a user to access and print information from files relating to a variety of coupons, each such coupon being associated with one or more categories, such as distinct geographic regions, distinct demographic characteristics, or distinct themes, such as sports, fashion, entertainment, etc.

In a preferred embodiment of the instant invention, a number of coupon files 210 are provided on the CD-ROM referring to a wide variety of coupons from sources that are widely geographically dispersed. Each coupon file includes textual information relating to the specific discount offer, and may also include textual and/or graphical information relating to the terms and conditions associated with the offer, visual images relating to the coupon provider's goods or services, textual information, visual images, and/or multimedia files describing the coupon provider's goods or services or instructions for their use, and any other information that a coupon provider may wish to relay to a consumer, as will be discussed in greater detail below.

In the preferred embodiment depicted in FIG. 2, each such coupon file is in turn associated with a particular regional access code 220. It is important to note, however, as discussed above, that the electronic coupons stored on the CD-ROM may alternately be categorized based upon particular demographic characteristics of persons who may be inclined to use the products or services the coupon describes, or based upon a particular theme relating to the goods or services offered in a certain collection of coupons (e.g., sports, fashion, etc.), with a unique access code being associated with each such categorization. A regional access code preferably comprises a random, 16 digit, alpha-numeric access code (which provides approximately 10 trillion different combinations) that must be received by the software as a user input in order to enable a print function for a particular group of coupons associated with such regional access code. In the embodiment depicted in FIG. 2, a separate regional access code, which is embodied in the 16 digit, alpha-numeric code, is provided for each distinct geographical region in which the coupons are to be distributed. For example, a distinct regional access code may be assigned to each state, such that all coupons relating to goods or services provided within a single state will have a common regional access code. Alternately, a regional access code may be assigned to a particular numeric series of postal zip codes, such that all coupons relating to goods or services provided in any one of a particular range of zip codes will likewise have a common regional access code.

The software is also provided a director function 230 which communicates with a user preference file 235 stored on a memory storage device 236 on the user's local computer, receives user inputs and information relating to previously identified region codes from the local computer's memory storage device 236, selectively enables a print function 240 to print coupons corresponding to a user-inputted access code to a local printer 245, enables a display function 250 to display to a local video terminal 255 user-selected coupon related information, and, in response to particular user selections and/or instructions, initiates an external browser software and communications software 260 to cause the consumer's local computer to access and communicate with a remote server. The director function, as well as the process of associating particular coupons with particular access codes, is accomplished through a readily commercially available computer software package for assisting in the creation and modification of computer interface screens, which software packages typically enable a programmer to design the layout of a display screen such as the size, character, and placement of buttons and windows on the screen and combine text, graphics, audio and video into a user-friendly application screen interface. In general, such authoring tools comprise prewritten computer code having a functionality for reading a data structure that defines a task to be taken and performs the task based on the data. High-end authoring systems have the capability to integrate different media and they include full application-building programmability similar to that found in database packages. Most authoring tools define a screen and the specific attributes of the screen such as the definition of a video window that will play a specified video clip or show a text file or graphic image. The use of such tools will be apparent to those or ordinary skill in the art when combined with the foregoing description and additional content which follows. For example, various methods and techniques for defining and displaying windows with associated task bars and buttons are well known in the art, as are methods and techniques for displaying bitmaps and multimedia files in such windows. As such, the present invention can be implemented with success with any of various off-the-shelf multimedia or other design tools. Specific examples of such computer application software authoring tools include Macromedia Director available from Macromedia, Inc., Asymmetrix Multimedia ToolBook, and Oracle's Media Objects. However, one skilled in the art will recognize that other commercially available programs could also be used to author such interfaces and to define and translate the commands implemented by the instant invention.

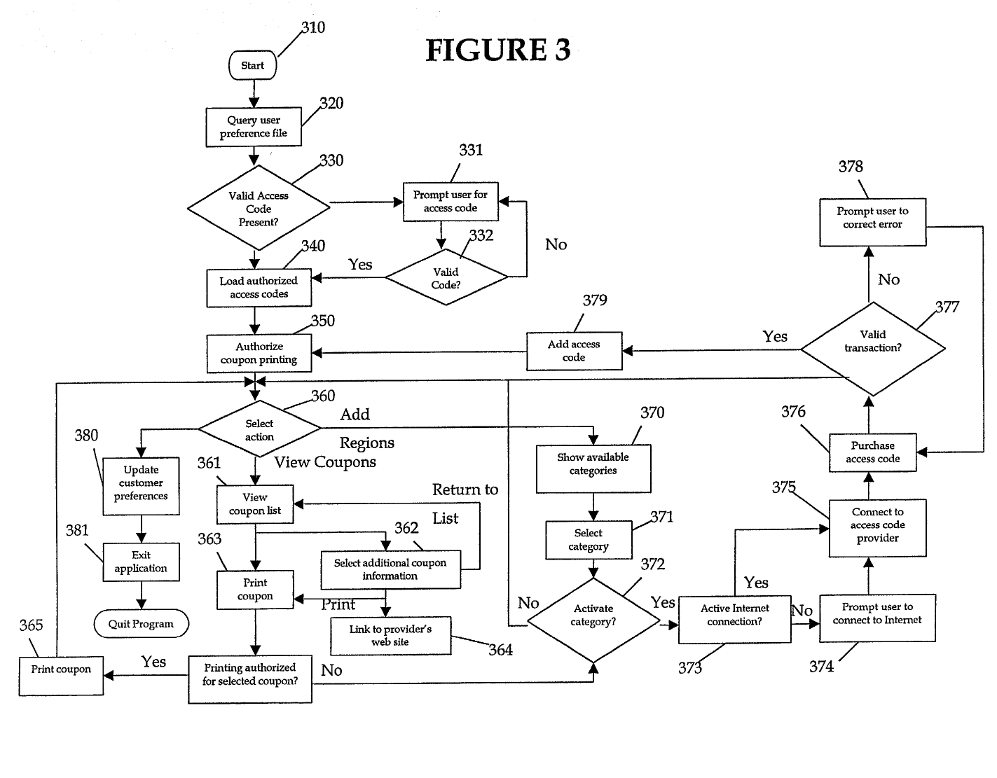

As shown in the schematic flowchart of FIG. 3, the software is initiated when the consumer places the CD-ROM in a compatible disc drive located on the consumer's local computer, either through an auto-run function enabled by the operating system on the local computer, or through the user's specific instruction to run the executable file on the CD-ROM, both of which techniques are well known in the art.

After the software has initiated at step 310, and as mentioned briefly above, at step 320 the software accesses a user preference file stored on a memory storage device on the consumer's local computer. Such preference files are often generated during the installation of new programs on a user computer to record computer-specific and user-specific information relating to software elements installed on that machine. Such preference files may be written to and continuously accessed through, for example, the MICROSOFT WINDOWS registry, or may alternately comprise a separate data file accessed by the software of the instant invention at the start of each execution of the program. The software accesses the local preference file in order to scan for any access codes that had previously been entered by the user. If the consumer is using the software for the first time, no access codes will be present in the preference file, and the software will prompt the user at step 331 to input an access code. At step 332, the software then compares the user-input access code through a check-sum program, which verifies the entered code as being valid, and then to all region codes 220 (FIG. 2) stored on the CD-ROM in order to determine whether the user-input code matches any of the stored access codes. If the user has entered an invalid access code, the software will respond with a message to the user indicating that the code the user entered is invalid, and will again prompt the user to enter a valid access code.

Once the user has entered a valid access code, or in the case where the user has previously used the software such that an access code has already been written to the user preference file on the local computer, at step 340 the software receives as input any access codes stored on the local computer's memory storage device or any access code input by the user at step 331, and in turn authorizes a print function at step 350 for all coupons associated with the access codes input to the software at step 340. Step 350 may comprise, for example, the creation of a temporary file which maintains a list of all access codes for which such print function has been authorized.

Optionally, after the software has authorized a print function at step 350, the software may prompt the user to input certain biographic and demographic information, including by way of example only the user's name, address, telephone number, email address, age, gender, etc. As the user inputs such biographic and demographic information, the information is likewise written to the user preference file stored on the user's local computer. Such information is thus held in memory on the user's local computer, and can be copied and forwarded to a remote server administered by a coupon provider upon the user establishing remote communication with such a server, for purposes of collection marketing-related biographic and demographic data concerning the users of such coupon provider's goods and services. As explained in greater detail below, such information may also optionally be accessed when the software initiates a print function in order to print certain identifying information about the authorized coupon user (e.g., name, address, etc.) in order to allow an employee of the retail establishment to confirm (e.g., by examining both the coupon and a photo identification of the user) that the person attempting to redeem the coupon is in fact the same person that purchased the coupon.

After the print function has been authorized for the relevant coupons associated with the input access codes, the software presents a multi-window user interface at step 360 which enables a user to select from a variety of software functions (graphically depicted by buttons on the user interface), including viewing coupon records, adding additional access codes, or quitting the program.

When a user elects to view coupon records at step 361, a number of coupon records are displayed at one time. The user may select a first software function associated with each displayed coupon record which causes the software to initiate a software print function at step 363, or may select a second software function which causes the software to display more detailed information pertaining to a user-selected individual coupon record at step 362. If the user elects to display additional information at step 362, a single coupon record is presented which includes textual information relating to the precise discount offer made available through the coupon on the CD-ROM, and which optionally includes multimedia content which describes the coupon provider's goods or services relating to the coupon, other goods or services available, instructions on use of the coupon provider's goods and services, general advertising information of the coupon provider, or any other information that the coupon provider wishes to present to the user. When viewing such a single coupon record with or without multimedia content, a user may select a software function which causes a print function to be initiated for the coupon relating to the record being viewed at step 363, or a software function which causes the software to return to step 361 and display the full list of coupons available. Additionally, and as will be described in greater detail below, the single coupon record may present the user with a selective software function at step 364 which causes a browser software program stored on the user's local computer to be initiated which establishes communication with a remote terminal through a wide area network such as the Internet, such remote terminal interfacing with a computer server controlled by the coupon provider, in turn enabling the transfer of information between the user and the specific coupon provider's server.

When the software is caused to initiate a print function at step 363, the software first queries the temporary file created during step 350 to determine whether the coupon that was selected for printing is associated with an access code that was authorized during step 350. If the coupon is associated with an access code that was previously authorized, then at step 365 the software directs a print command to a local printer attached to the user's computer which in turn causes the coupon being viewed to be printed. After the print command is executed, the user is directed back to step 360 to select another action. Likewise, if the coupon is not associated with an access code that was previously authorized, then the software prompts the user at step 372 for input indicating whether the user wishes to purchase the access code for the user-selected coupon.

When so prompted, a user may elect not to purchase the access code associated with the coupon then being viewed, in which case the software terminates the display of the user-selected coupon and returns the user to the multi-window user interface at step 360. Likewise, a user may alternately elect to purchase the access code associated with the coupon being viewed, in which case the software initiates a remote communication function to purchase such access code from a remote server across a wide area network such as the Internet, as will be described in greater detail below.

Optionally, in the event that the software previously prompted the user to input biographical and demographic information, which information was in turn written to the user preference file, upon the initiation of a print function at step 363, the software may likewise query the user preference file on the user's local computer to obtain certain biographic information relating to the user, including by way of example only the user's name and address. After obtaining such information from the user preference file, the software may automatically print such information on the print copy of the coupon. The automatic printing of such information directly on the printed coupon in turn enables an employee of the retail establishment at which the user is seeking to redeem the coupon to confirm that the coupon presenter is actually the authorized coupon user. Thus, in the event that someone other than the person who actually purchased the CD-ROM bearing the electronic coupons attempts to redeem the coupon, the employee of the retail establishment may reveal this fact through analysis of the information printed on the coupon, and thus thwart such attempted unauthorized coupon use. While providers of printed coupon collections have in the past provided a separate, specially manufactured physical piece of identification (e.g., a plastic identification card imprinted with the purchaser's name, which card would be compared against a coupon presenter's standard identification) along with the printed coupon collection in order to limit use of the coupons solely to the actual purchaser of the coupon collection, the method of the instant invention provides such protection without requiring an additional piece of identification beyond the user's own standard identification (e.g., a driver's license). By eliminating the need for a separate means of identification to be provided with the coupon collection, manufacturing costs may be significantly reduced.

Directing attention again to step 360, a user may opt to add access codes prior to viewing individual coupon records. When this function is initiated, the software first displays a list of all categorizations (whether geographic region, demographic characteristic, general theme, or the like) available on the CD-ROM at step 370, and next prompts the user for input at step 371 indicating the specific categorization desired by the user. Once such a desired categorization has been identified at step 371, the software next prompts the user at step 372 for input indicating whether the user wishes to purchase the access code for the user-selected coupon, as explained above.

When the user elects at step 372 to purchase a new access code, the software first queries the local operating system at step 373 to determine whether an active connection exists between the local computer and the Internet. If such a connection exists, then at step 375 the software directs a browser software program to access a specific URL which identifies a server housing application software that enables the remote purchase of additional access codes. If an Internet connection does not exist, the software at step 374 prompts the user to initiate the browser and communications software on the user's local computer in order to establish such a connection, and once such connection is established, proceeds as above at step 375 to connect the user's local computer to the access code purchasing server. Alternately, the software may automatically initiate the browser and communications software programs stored on the local user's computer in order to establish the necessary remote connection. If for any reason it is not possible to establish a remote connection between the user's computer and the access code purchasing server, such as due to a lack of connectivity or Internet browser, the user is alternatively presented with a display including contact information, such as a toll free telephone number, fax number, mailing address, or the like which a user may access and/or contact in order to purchase the desired new access or update code. The code may then be provided to the user on a CD-ROM, diskette, or other computer readable storage medium, and will auto-install the new code to the user's preference file without displaying the code to the user, thus preventing the code from being repurposed in an unauthorized manner.

After the connection with the remote access code purchasing server has been established at step 375, the software automatically transmits to the remote server that portion of the user preference file stored on the user's local machine that indicates which access codes have previously been authorized. If no access codes have previously been authorized (as indicated by an absence of any access code entries in the user preference file), the software automatically terminates the connection between the user's local computer and the remote server. However, if at least one valid access code has previously been stored in the user's preference file stored on the local computer, the software running on the remote server may request input from the local user at step 376 relating to specific customer information, including the user's full name, address, phone number, type and model of computer, credit card information, and optionally additional demographic information (if said information is not already in the user's local computer and associated with the relevant preference file and access code), which information might later be used for marketing efforts. After the user has entered their customer information at step 376, the user's credit card or related financial information is validated at step 377. If the user's information cannot be validated, the user is prompted at step 378 to check the input data and to fix any errors that are evident, and is returned to step 376 to modify the data. Alternately should the user decide at this point to not purchase the new access code, the user may elect to quit the remote access code purchasing function and return to the multi-window user interface at step 360. However, if the user inputs valid financial information and such information is in fact validated at step 377, then the software running on the remote server transmits and writes to the local computer's user preference file the newly purchased access code at step 379, authorizes a print function for all coupons stored on the CD-ROM relating to the newly purchased access code at step 350, and again presents to the user the multi-window user interface described above at step 360. By using such an automatic transfer of the new access code to the user preference file stored on the local computer, the new access code is never viewable to the user, thus preventing the unauthorized use by others of such additional region codes.

In addition to automatically transmitting to the remote server that portion of the user preference file indicating which access codes have previously been authorized, in an alternate embodiment of the instant invention, the software may likewise transmit that portion of the user preference file which includes the user's biographic and demographic information. Because the transfer of such information is automatic upon a user establishing communication with a coupon provider's remote server, the user need experience no obtrusive personal questioning each time he or she seeks to visit a coupon provider's web site or purchase additional access codes, but such coupon provider is still assured of collecting valuable marketing data relating to the demographic characteristics of users of its products and services.

Finally, a user may elect at step 360 to terminate the program. Selecting this software function causes the software to update the user preference file stored on the user's local computer at step 380, to ensure that the user preference file reflects all access codes that have been purchased by the user. After the local user preference file has been updated at step 380, the user may exit the application at step 381, and the program is terminated.

Optionally, a search function (not shown) is also provided which enables a user to search through the entire collection of coupons stored on the CD-ROM, preferably by keyword indexing, and optionally by zip code indexing to search specific geographic locations for discount offers.

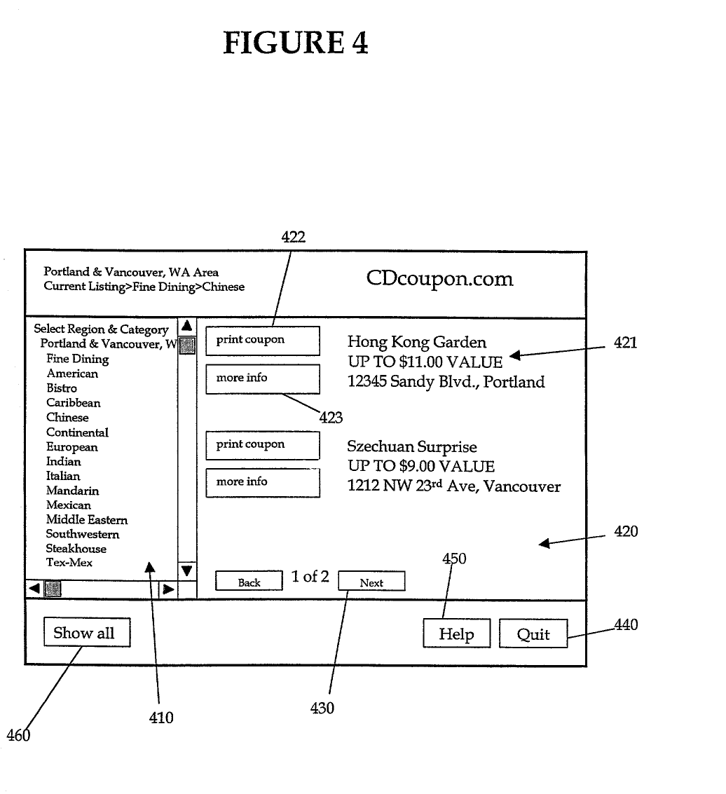

As mentioned above, at step 360 the user is provided a multi-window user interface. A graphical representation of this user interface for a system of the instant invention categorizing the coupons stored thereon by geographic region is provided in FIG. 4. A first window 410 of the interface (shown generally at 400) provides a hierarchical configuration of records depicting at the highest level each distinct geographic region represented on the software, then individual categories of goods and services available in each region. A second window 420 provides a list of all coupons available in a specific category or region selected in the first window, including a brief textual description 421 of the details of the coupon or discount offer, and buttons 422 and 423 associated with each coupon record in the second window which initiate software functions to either print a selected coupon offer (button 422) or to display additional detail relating to any selected coupon offer (button 423). By selecting any category of goods and services in window 410, window 420 displays all coupons within such category for a given region. A user may scroll through the list of coupons in window 420, and for large numbers of coupons under a single category, may go from page to page using page navigation buttons 430. User interface 400 also provides a button 440 to initiate a software function to terminate the program, and a button 450 to initiate a software function that initiates a help screen. Finally, user interface 400 provides a button 460 to initiate a software function that displays a listing of all coupons stored on the CD-ROM.

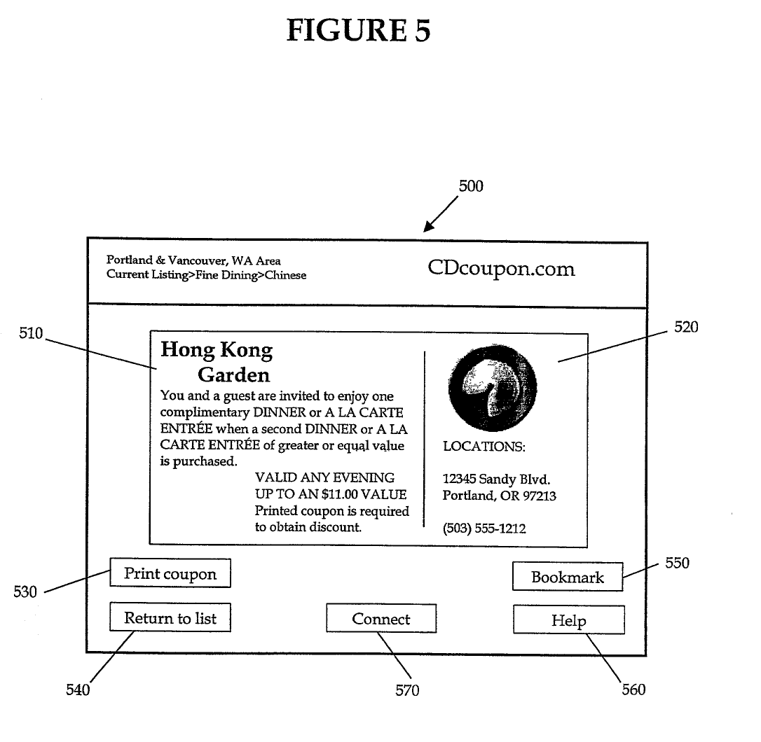

As mentioned above, a user may elect in user interface 400 to display additional detail relating to any selected coupon offer using button 423. A graphical display of a detailed coupon record is shown in FIG. 5. The coupon record (shown generally at 500) comprises textual and optionally graphical information 510 describing the coupon provider's goods and/or services and the terms of the coupon discount offer. The coupon record also comprises a media window 520 which may display graphical images or multimedia content relating to the coupon provider, including information regarding the particular goods or services referenced in the coupon, advertisement for additional products or services available from the coupon provider, instructions for using the provider's goods or services, technical information relating to the provider's goods or services, or any other information that the coupon provider might wish to present to the user.

A number of software functions are enabled through a series of buttons provided at the bottom of the coupon record 500, including a print function 530 which initiates the print function described above and shown in FIG. 3 at step 363, a return to list function 540 which returns the user to user interface 400, a bookmark function 550 which adds the displayed coupon to a list of coupons that may be accessed through a “favorites” category in window 410 of user interface 400, a help function 560 which initiates a help screen, and optionally a connect function 570 enabling the user to establish a remote connection with a coupon provider's Internet web site. In some instances, it may be desirable to coupon providers to have users go to the specific coupon provider's Internet web site, or alternately to a dedicated page at the specific coupon provider's web site, as the user is viewing the coupon provider's coupon. This may provide a valuable service to advertisers and consumers for various reasons, including real-time consumer updates, product information, rebates, sales, and to collect consumer information from those using the CD-ROM.

Connect function 570 directs a browser software program on the user's local computer to access a specific URL which identifies a server housing application software of the coupon provider. As explained above with respect to initiation of the remote region code purchase function in software step 373, if an Internet connection does not exist when the user attempts to connect to the coupon provider's site, the software may either prompt the user to initiate the browser and communications software on the user's local computer in order to establish such a connection, or alternately may automatically initiate the browser and communications software programs stored on the local user's computer in order to establish the necessary remote connection. After the connection with the remote coupon provider's server has been established, the software may again automatically transmit to the remote server that portion of the user preference file stored on the user's local machine that includes the user's biographic and demographic information, including by way of example only the user's name, address, and phone number, as well as the serial number for the software stored on the CD-ROM, in order to particularly identify an individual user of the CD-ROM. In this way, the web server at the specified URL would then recognize the CD-ROM over the Internet as being a CD-ROM distributed with a specific advertisement and printable coupon(s) as a part of a product/advertisement specific CD-ROM, or as one of many products/advertisements from a large selection of the same on the CD-ROM.

Additionally, the preference or registration file may also be continuously updated with information or “cookies” about how the user of the CD-ROM software navigates and uses the disc, as well as the types and numbers of coupons which the user of the CD software may be printing out on the computer's local printer, so that such information may likewise by automatically transmitted to a coupon provider's remote server upon a user initiating communication with such remote server.

Thus, when a user opts to connect to the Internet web site of the specific coupon provider, the software may automatically transmit to such remote server the preference file or registration file stored on the user's local memory storage device in a manner consistent with identifying the user as a registered user of the software, as well as gaining information about the manner in which the consumer has implemented and used the software and how many and which kind(s) of coupons may have been printed out for possible redemption. Knowing this information, the advertiser's web site could elect to automatically provide the user with selected product or coupon specific information and also to update the information files stored on the user's local computer.

In addition to the coupon features described above, the software of the instant invention also preferably comprises textual, graphical, multimedia, and/or interactive content and programs which are unrelated to the coupon offers stored on the CD-ROM, such as games, stories, movies, or other entertainment items. Providing such unrelated yet entertaining additions to the coupon collection stored on the CD-ROM enhances its appeals far beyond traditional coupon collections, providing additional incentives for a wider population of consumers to purchase and utilize such a collection.

In a first embodiment of the instant invention, games may be provided in addition to the electronic coupons and control program. While such games are preferably of a subject matter unrelated to coupon offers, such as arcade or trivia games, in order to even further increase a user's exposure to the coupons stored on the CD-ROM, users may be rewarded for reaching particular scores or levels of achievement in those games with particular coupons or other discount offers. For example, when playing a trivia game stored on the CD-ROM and achieving a record high score, the user may be presented with a coupon offering a discount off of a future book purchase at a book store. Such discount offer may remain unavailable until a particular score in the game has been reached.

Moreover, the particular coupons or offers presented to the user upon reaching such a predesignated “high score” may be established using the access code input by the user upon initiation of the software. Thus, just as the collection of coupons made available for printing may be customized through user input of an access code, the collection of coupons or offers presented to the user upon reaching a high score may likewise be customized. In order to provide such a customization, just as a user indicates a particular geographic region, demographic characteristic, or theme for coupons for which a print function shall be enabled, a user may likewise select a “prize category”, i.e., a collection of coupons, discount offers, and the like relating to goods or services that share a common theme which may coincide with the theme for a game provided on the CD-ROM. Thus, by way of example only, a user may elect to play a sports-theme trivia gamed, and upon reaching a predesignated high score, may be presented with coupons or other offers for sporting goods and/or sporting events.

In addition to games, such coupon unrelated content may also include other types of entertaining multimedia content, such as interactive stories, movies, and any other general entertainment content which draws a user to engage the CD-ROM, and thus obtain exposure to the collection of coupons stored thereon.

Moreover, in addition to providing customized coupons or other offers as rewards for achieving predesignated high scores in games stored on the CD-ROM, the system of the instant invention may likewise employ the access code and the user' own biographic and demographic information to customize the particular games or other multimedia entertainment items provides on the CD-ROM. For example, a user who selects a sports theme when first ordering a CD-ROM will generate an access code which will provide access to sports-related coupons, in addition to sports-related games and multimedia information. The customization of such coupon unrelated information can then in turn be even further customized, for example, by comparing the user's age (stored in the preference file with the user's biographic and demographic information) to age collections of sports-related content, such as modern sports content for persons aged 5-20, sports content from the 1970's and 1980's for persons ages 20-55, and sports content prior to 1970 for persons over age 55. A method and system for providing such a customization of coupon-unrelated content is particularly disclosed in the inventor's copending patent application ser. Nos. 09/377,108 and 09/773,726.

While the preferred forms and embodiments of the invention have been illustrated and described, it will be apparent to those of ordinary skill in the art that various changes and modifications may be made without deviating from the inventive concepts and spirit of the invention as set forth above, and it is intended by the appended claims to define all such concepts which come within the fall scope and true spirit of the invention.

1. A method for distributing electronic coupons comprising the steps of:
(a) providing a remote host electronic coupon ordering system;
(b) causing said ordering system to prompt a user to select coupon customization criteria;
(c) using said customization criteria to generate an alpha-numeric access code; and
(d) providing in combination said access code and a computer-readable storage medium containing a control program, a non-customized collection of electronic coupons, and coupon unrelated content to said user, said control program being operable in response to input of said access code to limit a user's access to said non-customized collection of electronic coupons to a discrete, customized collection of said non-customized electronic coupons.

2. The method of claim 1, said control program being further operable in response to a request from said user to obtain an additional access code to establish remote communication between a computer used by said user and said ordering system, said method further comprising the steps of:
(e) establishing remote communication between said computer used by said user and said ordering system after said access code and said computer readable storage medium have been provided to said user;
(f) causing said ordering system to prompt said user to select alternate coupon customization criteria;
(g) using said alternate coupon customization criteria to generate an alternate alphanumeric access code; and
(h) transmitting said alternate access code to said computer used by said user, said control program being operable in response to input of said alternate access code to modify said user's access to said non-customized electronic coupons to include an additional discrete, customized collection of said non-customized electronic coupons.

3. The method of claim 2, wherein step (h) of transmitting said alternate access code is conducted without displaying said alternate access code to said user.

4. The method of claim 2, said control program being further operable to prompt said user to input biographic and demographic data and to write said biographic and demographic data to a memory storage device on said computer, said method further comprising the step of receiving from said computer said biographic and demographic data after establishing remote communication between said computer used by said user and said ordering system.

5. The method of claim 1, wherein said step of causing said ordering system to prompt said user to select coupon customization criteria further comprises prompting said user to indicate a specific geographic region in which said customized collection of coupons may be redeemed, said control program being further operable in response to input of said access code to limit a user's access to said non-customized collection of electronic coupons to a discrete, customized collection of said non-customized electronic coupons which may be redeemed within said specific geographic region.

6. The method of claim 1, wherein said step of causing said ordering system to prompt said user to select coupon customization criteria further comprises prompting said user to indicate specific biographic and demographic data, said control program being further operable in response to input of said access code to limit a user's access to said non-customized collection of electronic coupons to a discrete, customized collection of said non-customized electronic coupons which are predesignated to correspond to said biographic and demographic data.

7. The method of claim 1, wherein said step of causing said ordering system to prompt said user to select coupon customization criteria further comprises prompting said user to indicate a specific theme of coupon offers, said control program being further operable in response to input of said access code to limit a user's access to said non-customized collection of electronic coupons to a discrete, customized collection of said non-customized electronic coupons which are predesignated to correspond to said theme.

8. The method of claim 1, further comprising the steps of:
(e) causing said control program to request said access code from said user; and
(f) using said access code to limit a user's access to said non-customized collection of electronic coupons to a discrete, customized collection of said non-customized electronic coupons.

9. The method of claim 8, further comprising the steps of:
(g) displaying to said user a user interface comprising:
(i) a listing of electronic coupons in said customized collection;
(ii) means for initiating a display of a single one of said electronic coupons in said customized collection; and
(iii) means for initiating a display of coupon unrelated information.

10. The method of claim 9, further comprising the steps of:
(h) receiving as input a user selection of a single one of said electronic coupons in said customized collection;
(i) displaying a single coupon record to said user, said single coupon record further comprising a description of a discount offer associated with said single one of said electronic coupons in said customized collection and means for initiating a print function for printing said single coupon record.

11. The method of claim 10, further comprising the steps of:
(j) prior to displaying said user interface, prompting said user to input biographic and demographic data, and writing said biographic and demographic data to a memory storage device on a computer used by said user; and
(k) after displaying a single coupon record, and in response to receiving a user instruction to initiate said print function, printing said coupon record with at least a portion of said biographic and demographic data being printed thereon.

12. The method of claim 10, said single coupon record further comprising means for establishing communication between a computer used by said user and a remote Internet web site associated with a provider of said single coupon record, said method further comprising the steps of:
(j) prior to displaying said user interface, prompting said user to input biographic and demographic data, and writing said biographic and demographic data to a memory storage device on said computer; and
(k) after displaying said single coupon record, and in response to receiving a user instruction to establish communication between said user computer and said remote Internet web site, establishing said communication and automatically transferring at least a portion of said biographic and demographic data to said remote Internet web site.

13. The method of claim 10, further comprising the steps of:
(j) in response to receiving a user instruction to initiate said print function, printing said single coupon record with at least a portion of said biographic and demographic data being printed thereon without limiting a number of additional times that said single coupon record may be printed.

14. The method of claim 8, further comprising the steps of:
(g) using said access code to limit a user's access to said coupon unrelated content to a discrete, customized collection of said coupon unrelated content.

15. The method of claim 14, wherein said coupon unrelated content further comprises a game, further comprising the steps of:
(h) causing said control program to display a coupon to said user upon said user achieving a predesignated accomplishment in said game; and
(i) causing said control program to prompt said user to print said coupon.

16. The method of claim 14, wherein said coupon customization criteria further comprises biographic and demographic information relating to said user, and said step of limiting a user's access to a discrete, customized collection of said coupon unrelated content further comprises displaying coupon unrelated information to said user that is predesignated as being associated with said biographic and demographic information.

17. The method of claim 16, said coupon unrelated information further comprising a trivia game, and said step of displaying coupon unrelated information further comprises displaying trivia questions that are predesignated as being associated with said biographic and demographic information.

18. In combination, a printed alpha-numeric access code and a computer-readable storage medium containing computer executable code for instructing a computer to operate in a particular manner when used by a computer, said computer-readable storage medium comprising:
a first collection of data objects comprising a non-customized collection of electronic coupons;
a second collection of data objects comprising access codes, each said access code corresponding to at least one of said electronic coupons; a third collection of data objects comprising coupon unrelated content; and a control program operable to instruct a computer to operate as follows:
(i) directing the computer to prompt a user to input said printed access code;
(ii) directing the computer to receive as input from said user said access code;
(iii) directing the computer to compare said access code input from said user with said second collection of data objects; and
(iv) directing the computer to limit a user's access to said first collection of data objects to a discrete, customized collection of electronic coupons corresponding to said access code input by said user.

19. The combination of claim 18, said control program further being operable to instruct a computer to operate as follows:
(v) directing the computer to display a listing of all electronic coupons stored on the computer-readable storage medium;
(vi) directing the computer to receive as input a user selection of a single one of said electronic coupons;
(vii) directing the computer to display a single one of said electronic coupons in response to a user selection;
(viii) directing the computer to receive as input a user instruction to print said displayed electronic coupon; and
(viii) in response to a user instruction to print a user-selected electronic coupon, directing the computer to print said user selected electronic coupon if said coupon is included in said discrete, customized collection of electronic coupons corresponding to said access code input by said user.

20. The combination of claim 19, said control program further being operable to instruct a computer to operate as follows:
(ix) in response to a user instruction to print a user-selected electronic coupon, directing the computer to establish communication with a remote host electronic coupon ordering system;
(x) directing the computer to transmit to said remote host electronic coupon ordering system coupon customization criteria;
(xi) directing the computer to receive as input from said host electronic coupon ordering system an alternate alpha-numeric access code and to write said alternate alpha-numeric access code to a memory storage device on the user's computer;
(xii) directing the computer to compare said alternate access code with said second collection of data objects; and
(xiii) directing the computer to modify said user's access to said first collection of data objects to include an additional, discrete, customized collection of electronic coupons corresponding to said alternate access code.

21. The combination of claim 20, said control program further being operable to instruct the computer to receive as input from said host electronic coupon ordering system said alternate access code without displaying said alternate access code to said user.

22. The combination of claim 19, said control program further being operable to instruct a computer to operate as follows:
(ix) directing the computer to prompt a user to input biographic and demographic information;
(x) directing the computer to receive as input from said user said biographic and demographic information; and
(xi) in response to said user instruction to print a user-selected electronic coupon, further directing the computer to print said user selected electronic coupon if said coupon is included in said discrete, customized collection of electronic coupons with at least a portion of said biographic and demographic information printed thereon.

23. The combination of claim 19, said control program further being operable to instruct a computer to operate as follows:
(ix) directing the computer to prompt a user to input biographic and demographic information;
(x) directing the computer to receive as input from said user said biographic and demographic information;
(xi) directing the computer to receive as input a user instruction to establish communication with a remote web site corresponding to a provider of said user-selected electronic coupon;
(xii) in response to a user instruction to establish communication with said remote web site, directing the computer to establish communication with said remote web site; and
(xiii) directing the computer to transfer at least a portion of said biographic and demographic information to said remote web site.

24. The combination of claim 18, wherein each said access code further corresponds to at least one item of said coupon unrelated content, said control program further being operable to instruct a computer to operate as follows:
(v) directing the computer to limit a user's access to said third collection of data objects to a discrete, customized collection of coupon unrelated content corresponding to said access code input by said user.

25. The combination of claim 24, said coupon unrelated content further comprising a game, and said control program further being operable to instruct a computer to operate as follows:
(vi) directing the computer to display a coupon to said user upon said user achieving a predesignated accomplishment in said game; and
(vii) directing the computer to prompt said user to print said coupon after it is displayed.

26. The combination of claim 24, said coupon unrelated information further comprising a trivia game, and said instruction of directing the computer to limit a user's access to said third collection of data further comprises instructing the computer to display questions that are predesignated as being associated with said access code.

27. A system for distributing electronic coupons, comprising:
a server computer hosting an electronic coupon ordering service accessible via client computers to a plurality of potential users, said server computer providing a user interface comprising input controls including means for enabling a user to select coupon customization criteria, and means for enabling a user to enter identifying and financial information,
means for generating an alpha-numeric access code using said coupon customization criteria;
means for printing said alpha-numeric access code; and
means for transmitting in combination said alpha-numeric access code and a computer-readable storage medium to said user, said computer readable storage medium containing a control program, a non-customized collection of electronic coupons, and coupon unrelated content, said control program being operable in response to input of said access code to limit a user's access to said non-customized collection of electronic coupons to a discrete, customized collection of said non-customized electronic coupons.

28. The system of claim 27, further comprising:
alternate access code ordering means for receiving a request from said user to obtain an alternate access code, enabling said user to select alternate coupon customization criteria, generating an alternate access code using said alternate coupon customization criteria, and automatically transmitting to a computer used by said user said alternate access code.

29. The system of claim 28, said alternate access code ordering means further comprising means for automatically transmitting said alternate access code to said computer without displaying said alternate access code to said user.

30. The system of claim 27, said means for enabling a user to select coupon customization criteria further comprising means for instructing a user to indicate a specific geographic region in which said customized collection of coupons may be redeemed, wherein said customized collection of said non-customized electronic coupons comprises a collection of coupons redeemable within said specific geographic region.

31. The system of claim 27, said means for enabling a user to select coupon customization criteria further comprising means for instructing a user to indicate a specific biographic and demographic data, wherein said customized collection of said non-customized electronic coupons comprises a collection of coupons which are predesignated to correspond to said biographic and demographic data.

32. The system of claim 27, said means for enabling a user to select coupon customization criteria farther comprising means for instructing a user to indicate a specific theme of coupon offers, wherein said customized collection of said non-customized electronic coupons comprises a collection of coupons which are predesignated to correspond to said theme.
